(19) United States
(12) Patent Application Publication
(10) Pub. No.: US 2019/0059572 A1
(43) Pub. Date: Feb. 28, 2019

(54) Welding Table Elevating and Rolling

(71) Applicant: John Chappelle Moody, Jacksonville Beach, FL (US)

(72) Inventor: John Chappelle Moody, Jacksonville Beach, FL (US)

(21) Appl. No.: 15/686,399

(22) Filed: Aug. 25, 2017

(51) Int. Cl. A47B 9/04; A47B 9/20; B60B 33/06; A47B 9/12; B23K 37/04

(52) U.S. Cl. CPC A47B 9/04; A47B 9/20; B60B 33/066; A47B 2009/043; B60B 33/063; B23K 37/0461; A47B 2009/046; A47B 9/12

(57) ABSTRACT

A welding table with elevation system, powered with cordless drill, gear reducer, chain, sprockets and, ultimately turning screw posts synchronously, lifting four telescoping legs. Maximum elevated height exceeds most work benches for height matching, and a minimum height goes lower than most low tables. Folding wheel system is independent, lever operated, and works in conjunction with the elevation system. Once table rolls into position, drill is activated, braking is instant, the table lifts itself from the wheels. Wheels are then folded up, a position necessary during minimum height, as the frame gets closer to the ground. This low height enables sitting roll stool usage, and knees and legs enter the rear frame opening. Two drawers above conceal the wheels, have a lever locking system, and necessary when rolling the table. The table top is heavy, one piece removable with normal modular patterned holes throughout, and the addition of large oval holes, and top side overhang, both establishing C-Clamp usage.

### BACKGROUND OF THE INVENTION

Welding and tables have been built over the years for various purposes, many shapes and sizes, and some evolving the art into new applications. In any industrial environment, tables are used throughout the manufacturing process for tasks such as welding, fabrication and assembly, while all demand accuracy, and judged by measuring the top surface, commonly within thousandths of an inch. Maintaining that precision while welding at high temperatures requires a robust, heavy table, one weighing a ½ ton plus. With a heavy table comes reassurance during welding as the heat is better absorbed, minimizing deflection, and maintaining meticulous specifications of the fabricated items.

There are many advantages for the heavy table compared to a light one, although, the they have had limits. The heavy tables generally hold the fabricated items with special clamps, each fitting patterned holes throughout the deck, and for most, these clamps are exclusive to that manufacturers table. Most clamps will not interchange, and these heavy tables will not accept a common C-clamp, as the holes are too small.

Outer side walls can be another limiting factor on heavy tables, they usually skirt down similar to a cube, eliminating top side overhang, and again, prevent C-clamps from being used. Sidewalls do equal strength, however, they also limit the table from being used like a desk, as knee's are blocked from entering underneath the top. A desk position can provide arm support, help prevent user fatigue, and ultimately result in better welding.

Moving the heavy tables is rarely done just because it's not easy, since they will require moving equipment such as a forklift, or crane. This equipment must fit through doors, clear overhead objects, and its weight must be added to the table when calculating floor load capacity. That total number can easily be ten thousand pounds using a small fork lift, equivalent to three cars.

Table height is the closing limiting factor here, in many ways it's constricting no matter what table, and the heavy tables are known to be low, most are supported with welded legs, and a few may offer bolted legs.

Some bolted leg tables offer height adjustment using predrilled holes, however, you are limited to the holes which are usually an inch or two apart. Tables do not have the ability to height adjust to the thousandth unless blocks and shims are used. Blocks and shims can become time consuming as every height adjustment will require lifting equipment, and the safety precautions of that equipment in a shop. Also, the table must be re-leveled each any every time the height is changed, consuming more time.

### SUMMARY OF THE INVENTION

This present invention relates to an improved Fabrication/Welding Table offering multi clamp use, a removable table top, an elevation system, a folding wheel system, and the ability to accept a person sitting on a roll stool. The table features coincide with one another, each enhancing the overall operation. The frame structure centralizes the additional forces of rolling and elevating, as it goes beyond the usual large table with free standing legs, and offers an upper and lower beam configuration utilizing many cross beams. These beams consist of large vertical solid upper beams and large lower tubular beams, all intersecting into the corner leg posts, generating top and bottom support. The top beams also utilize blind holes, accepting the removable, heavy one piece table top. The table top has modular patterned holes throughout, used for clamping or bolting, with six additional oval cut outs placed in key areas. These cut outs allow the standard C-clamp to be used on this table top while the modular holes can still be used, establishing a dual clamping one piece top. To further the C-Clamp capability, the upper beams are set inward under the top, creating side overhang around the perimeter and providing a lip to grab. The removable top also provides access to the independent elevation system beneath it, which is a reduction gear utilizing chain to drive four screw legs, telescoping in synch through a series of idlers and sprockets. This system will elevate this heavy table to full up, and full down using an 18 volt cordless drill, and one battery. This elevation system works together with the wheel system, as the table can be rolled into position, the drill then activated, and legs travel downward to the ground. Braking becomes instant once the legs touch the ground while the table lifts itself from the wheel system and demonstrating the alliance of these two independent systems. As the table begins traveling upward, leg mounted indicators stay still, pointing to the moving post height charts, providing the operator table height information from either leg. These leg indicators also control the tables maximum height and become legs stops as they physically touch a stop at maximum height, and maintain adequate leg inside the posts.

The maximum elevated height is slightly higher than most tables, workbenches, and sawhorses, enabling precise height matching when used in series among other tables. This height matching can be easily performed to the thousandth of an inch, stop anywhere without locks or pins, maintain 0.0 degrees rather moving or stopped, and done by itself, no lifting equipment. The lowest elevated height is achieved in conjunction with the folding wheel system, when they are folded up, the table is permitted closer to the floor. The folding wheel system is lever operated, wheels fold upward and towards each other, providing a longer wheelbase. The front wheels have suspension for uneven floors, providing several degrees of tilt, preventing frame deflection while rolling. The tables rear side has beam provisions for leg and knee entrance, designated for roll stool usage, and made possible with the elevation system at its lowest height. This creates the roll stool ability, and offers a desk feeling to a person sifting on a roll stool. The desk feeling is when the persons knees can enter underneath, and abdomen can press against the table, granting total arm support.

Table concludes with two open onboard drawers, both are locking using a cam system below, operated with a side lever, and required when the table rolls. Drawers are also positioned to conceal the wheel system below, giving the table a clean non complicated look.

### DESCRIPTION OF DRAWINGS

FIG. 1—Perspective view showing Table on the Wheel System.

FIG. 2—Perspective view showing Table Elevation System powered with a cordless drill.

FIG. 3—Perspective view showing Table Elevation System max UP wheels folded up.

FIG. 4—Perspective view showing Table Elevation System max DOWN, wheels folded up.

FIG. 5—Perspective view illustrating the Roll Stool opening on the rear capable of knee clearance even when elevated to the lowest height.

FIG. 6—Perspective view illustrating Table Top accepting multiple clamping, C-clamps, modular friction clamps and bolts.

FIG. 7—Perspective view illustrating Table Top side overhang large allowing C-clamps, and clearance for bolt heads.

FIG. 8—Perspective view illustrating Table Top cut outs from underneath accepting a full C clamp.

FIG. 9—Sectional profile view showing Table Top mounting to the frame.

FIG. 10—Perspective view showing Table Top mounting bolt arrangement.

FIG. 11—Perspective view showing table top off, and Elevation System detail from the input to the gear.

FIG. 12—Perspective view showing Elevation system reduction gear underside.

FIG. 13—Perspective and sectional view showing Elevation System reduction gear and both idler arm detail. Chain tight.

FIG. 14—Perspective view showing Elevation System reduction gear and adjusting idler. Chain loose.

FIG. 15—Perspective view of the Elevation System chain guides.

FIG. 16—Perspective, transparent view of the Elevation System chain guides, their mounting and relation to the post idlers.

FIG. 17—Exploded view of the Elevation System post idler assemblies.

FIG. 18—Perspective view of the Elevation System post idlers assemblies, corner posts, and drive shaft sprockets.

FIG. 19—Transparent view of the Elevation System post sprockets and elevating leg in relation to the driveshaft.

FIG. 20—Sectional view of the Elevation System frame corner posts thrust plates in relation to the rotating driveshaft.

FIG. 21—Sectional view of the Elevation System frame corner posts, elevating leg, leg stop, lifting nut, and driveshaft, all assembled.

FIG. 22—Perspective view showing Elevation System frame corner post sight glass and leg play adjuster.

FIG. 23—Transparent view of the Elevation System frame corner posts and the driveshaft lubrication through sight glass hole.

FIG. 24—Perspective view of the Elevation System leg stop and height gauge, left side.

FIG. 25—Perspective view of the Elevation System leg stop and height gauge, right side.

FIG. 26—Rear perspective view of the Elevation System leg stops and height gauges, both right and left.

FIG. 27—Perspective view illustrating the Wheel System and its partnership with the independent elevation system.

FIG. 28—Left side view of the Wheel System control handle being used.

FIG. 29—Perspective view showing the Wheel System folded down, with front and rear axle in relation to the frame.

FIG. 30—Profile view showing the Wheel System lever and bell crank detail, wheels folded down.

FIG. 31—Profile view showing the Wheel System lever and bell crank detail, wheels folded up

FIG. 32—Front perspective view of the Drawers position, closed and maximum opening.

FIG. 33—Right side view of the Drawers locking system control handle.

FIG. 34—Perspective view of the Drawers locking system, with cams from underneath.

### DETAILED DESCRIPTION OF THE INVENTION

The present Invention has a combination of features working in conjunction with each other, all necessary for the overall table abilities.

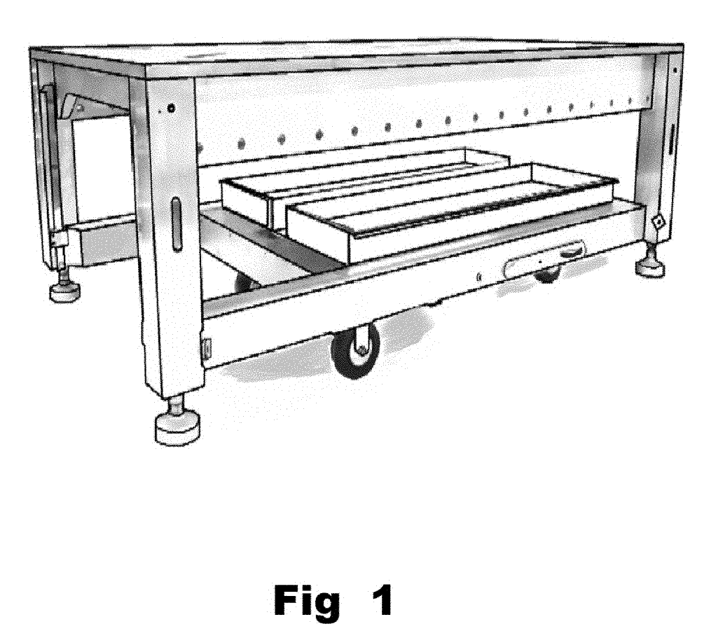

FIGS. 1-9 Features overall . . . Part numbers/No

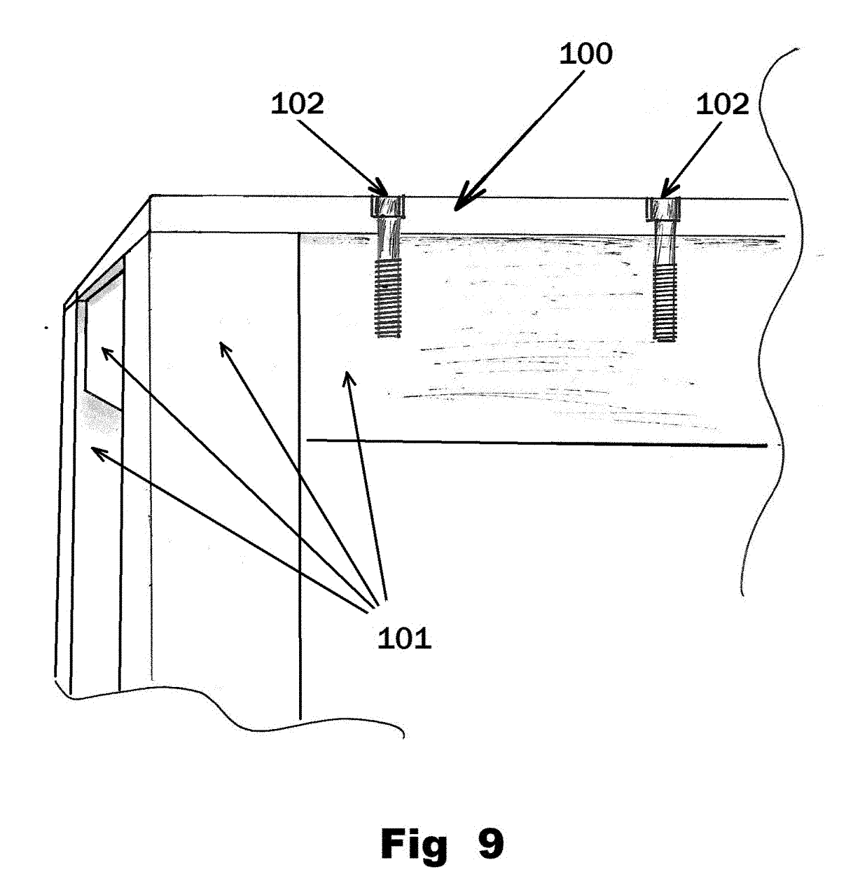

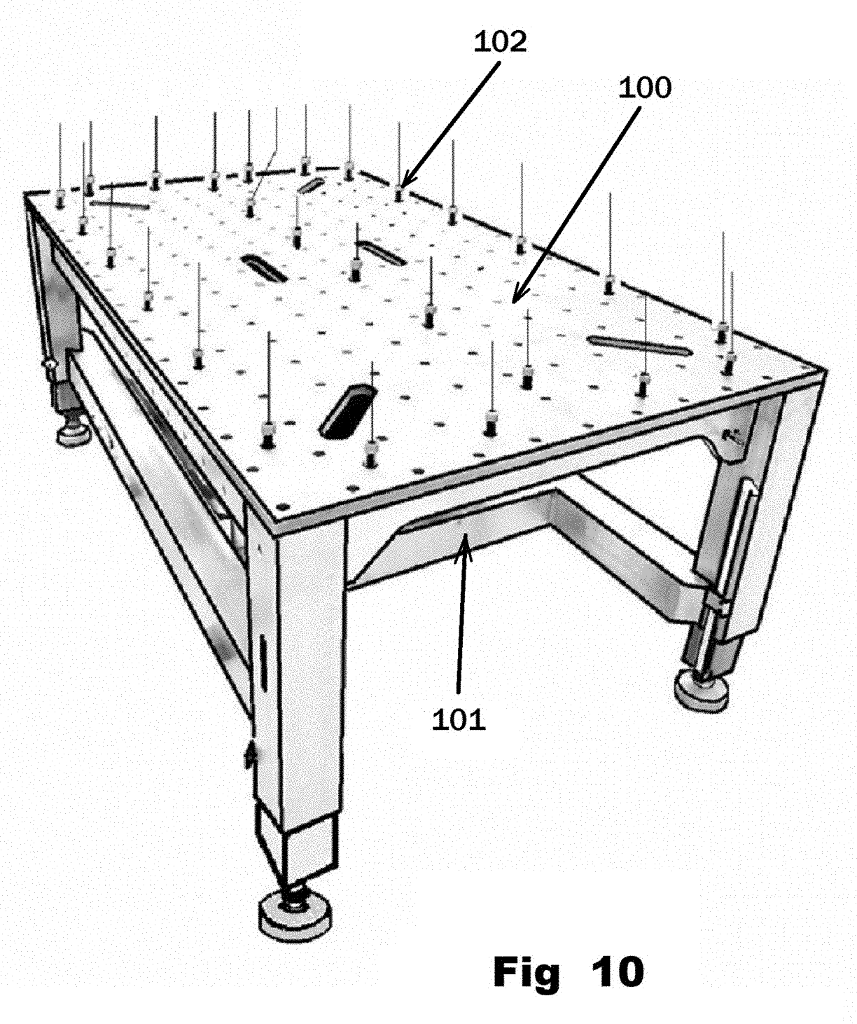

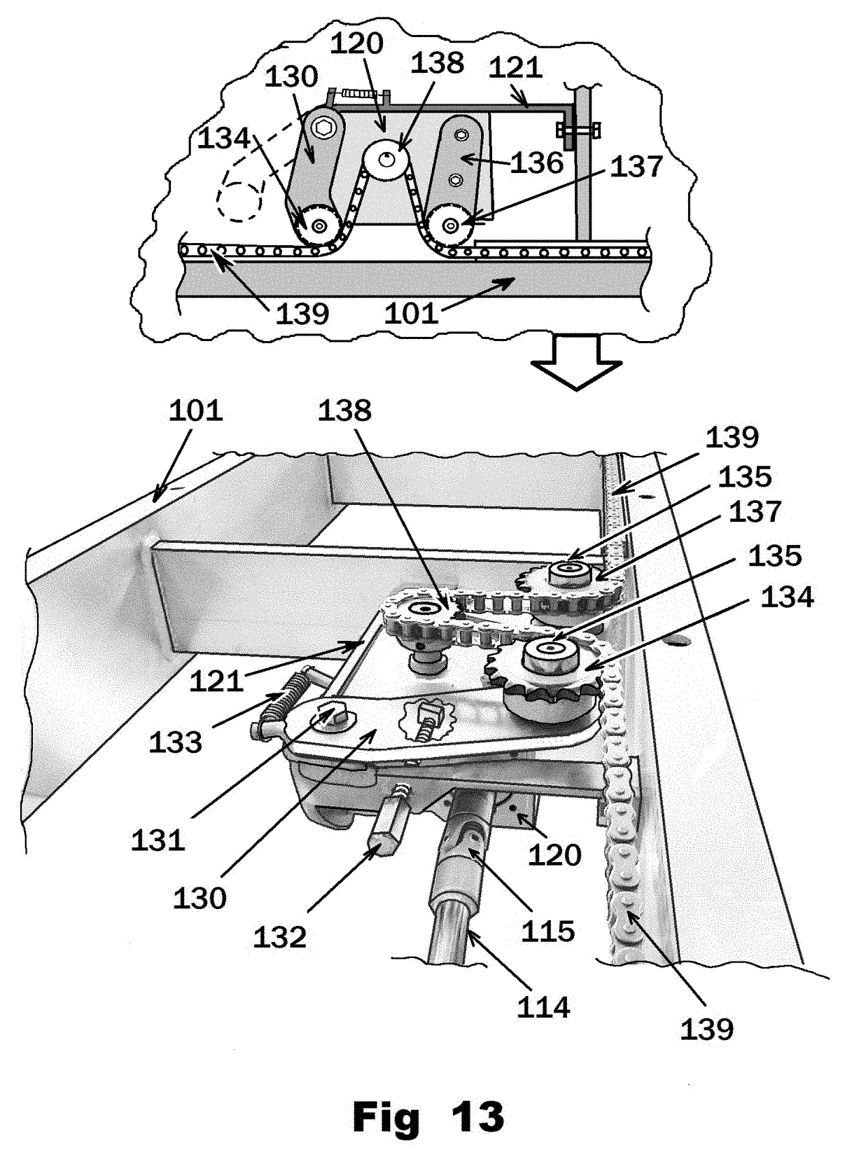

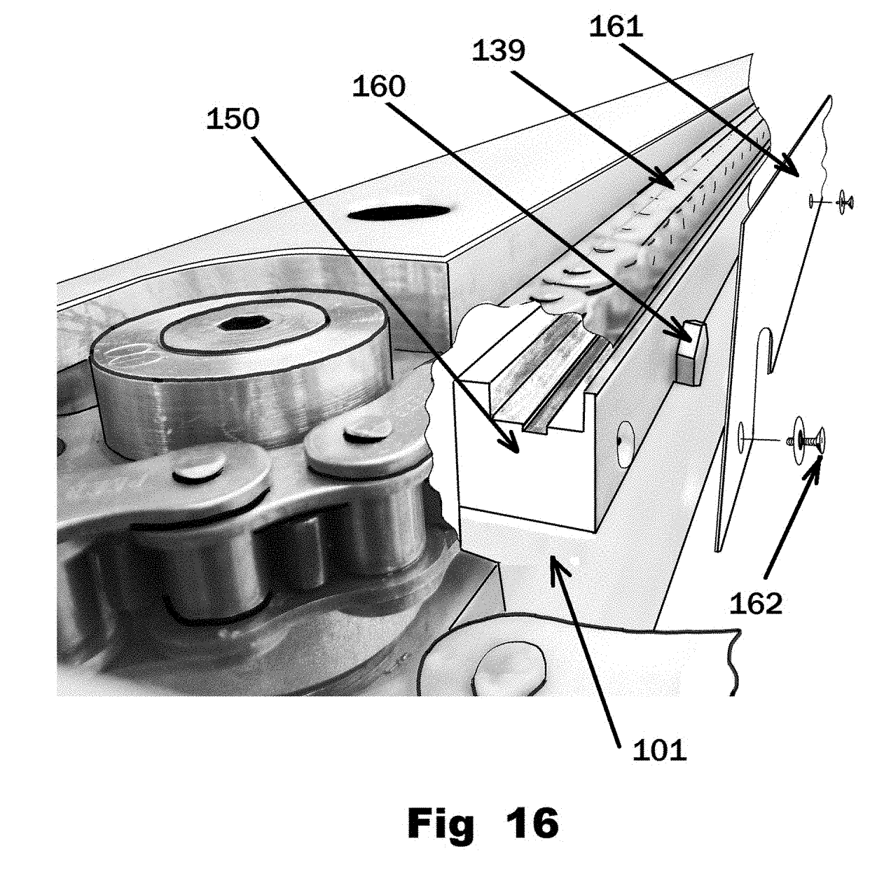

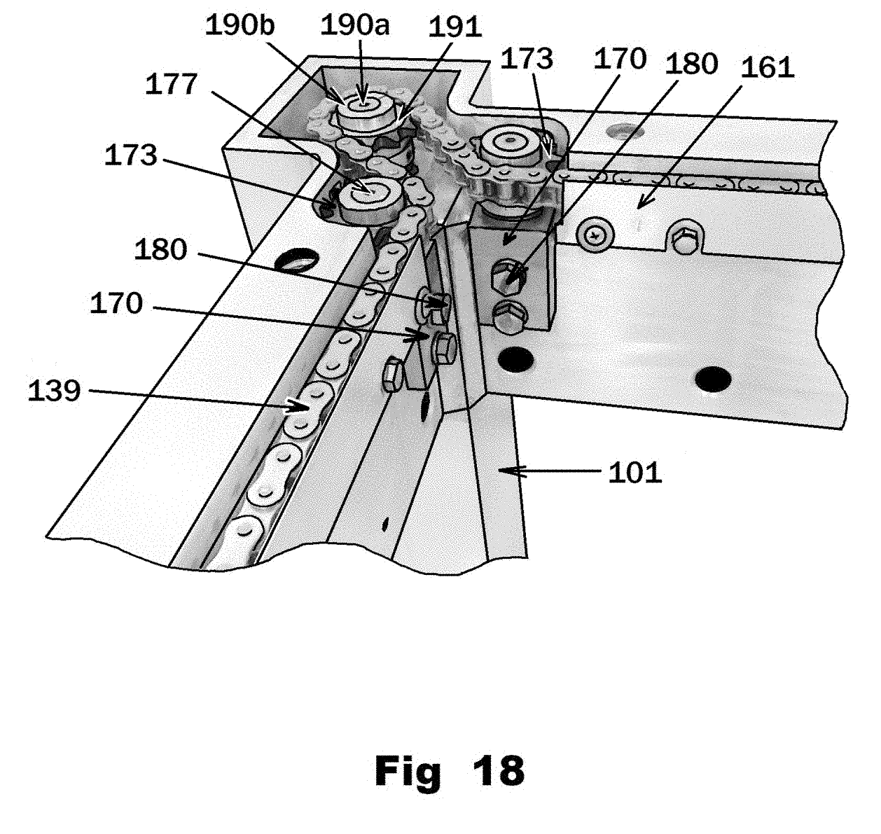

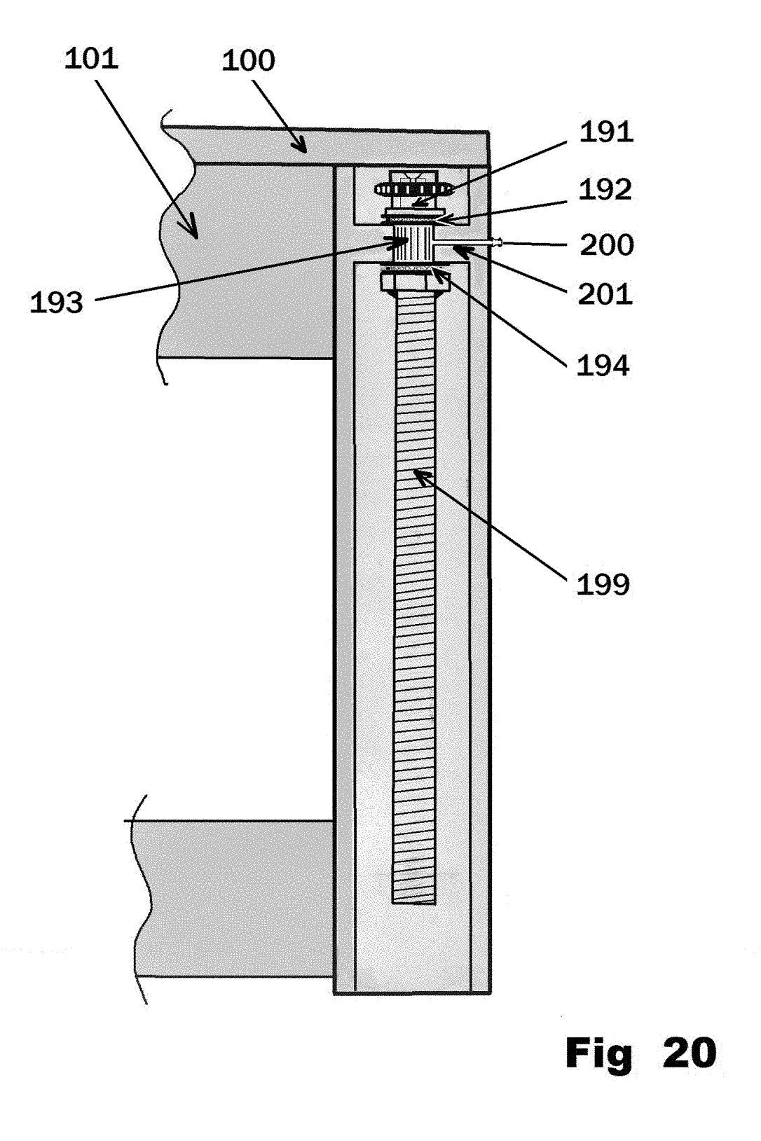

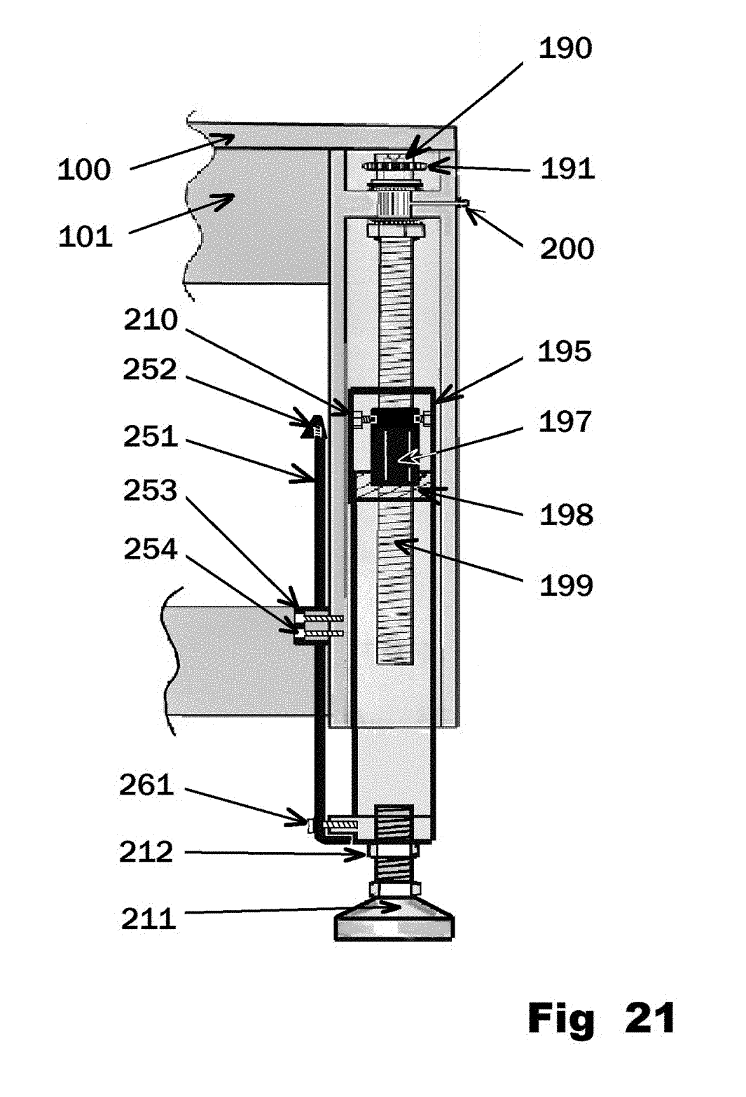

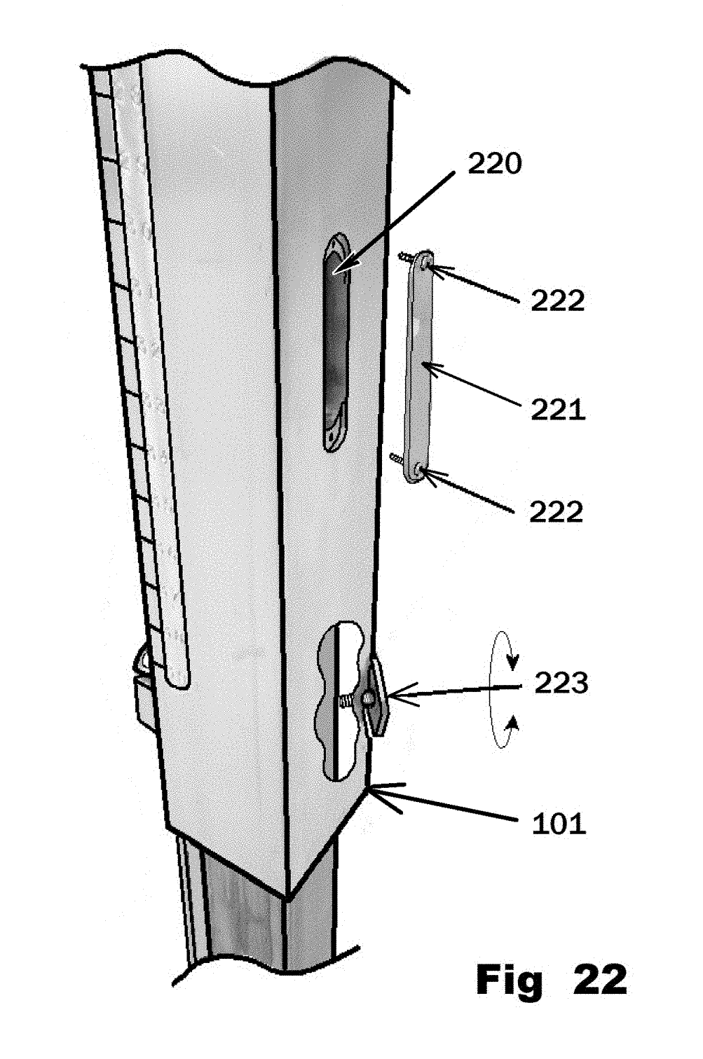

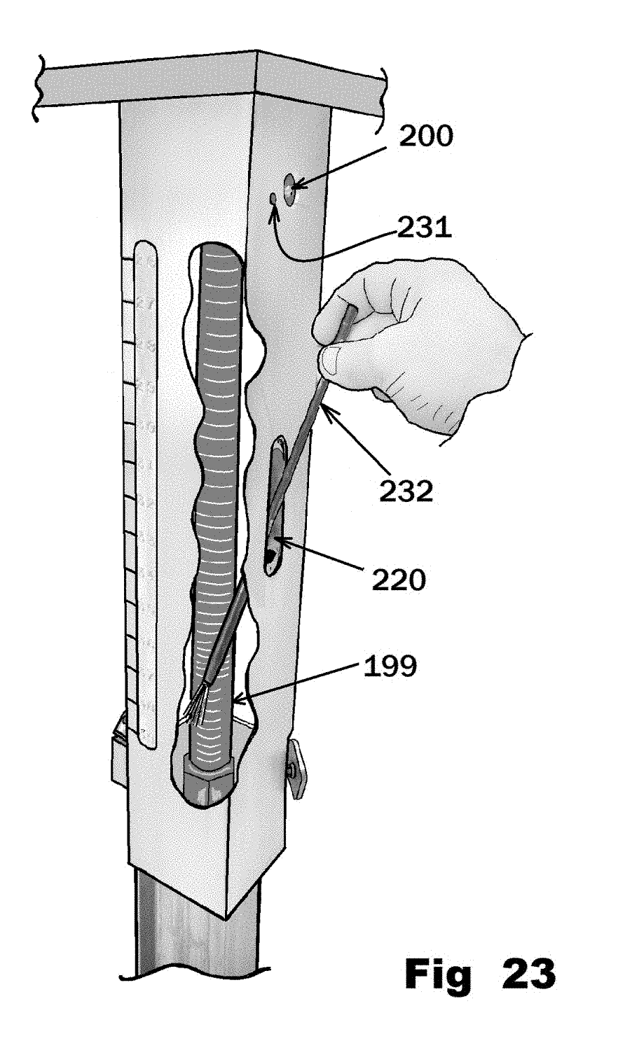

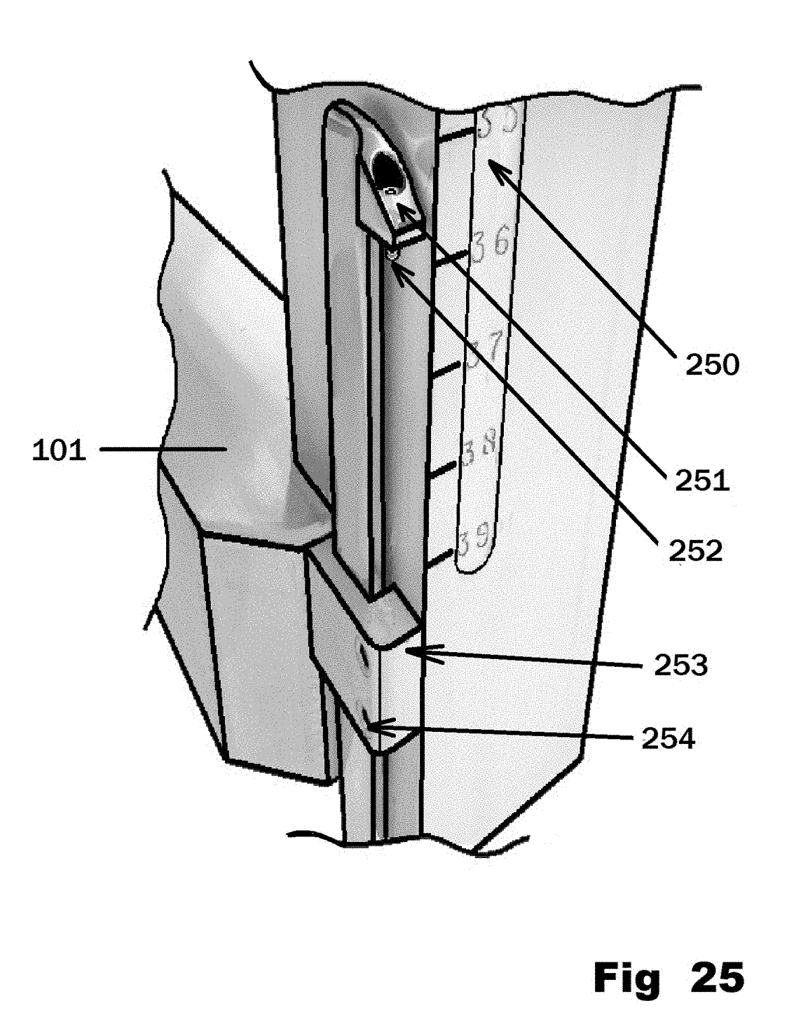

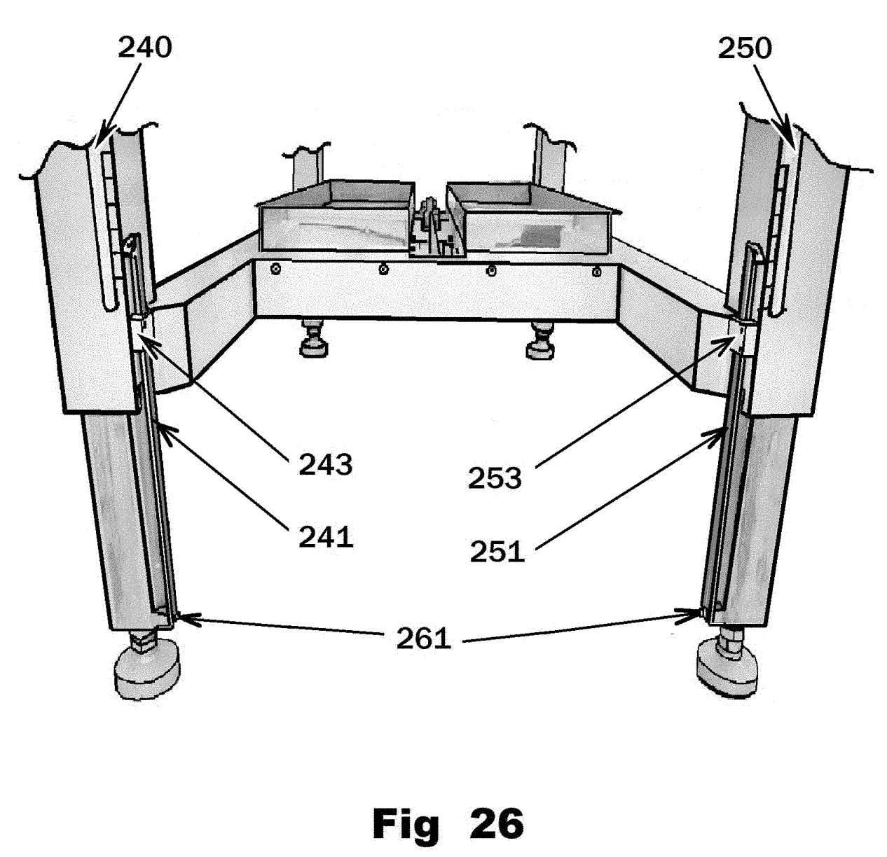

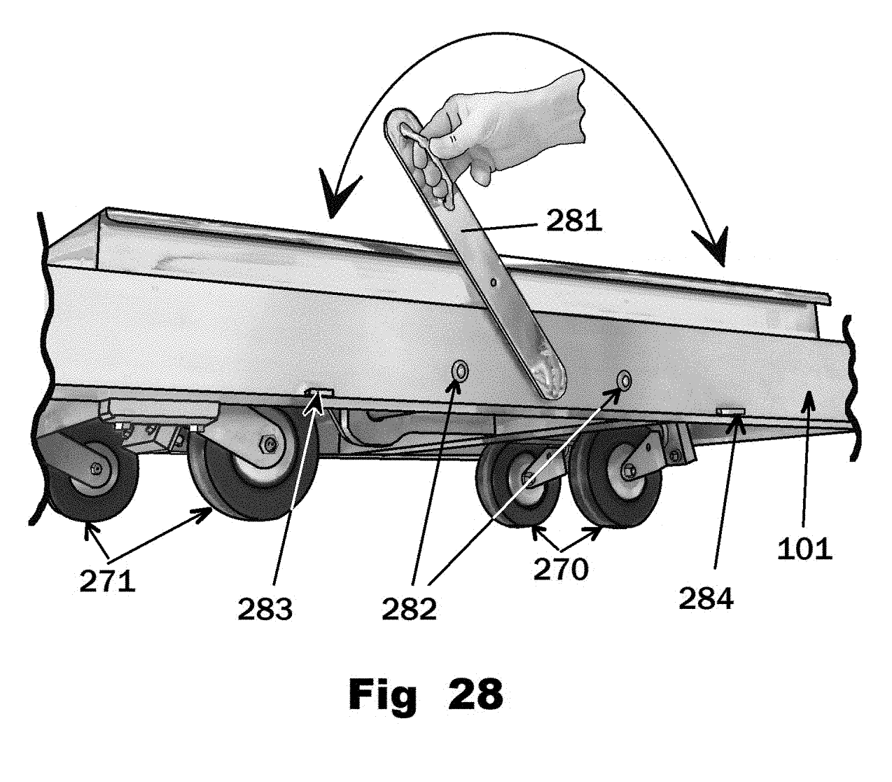

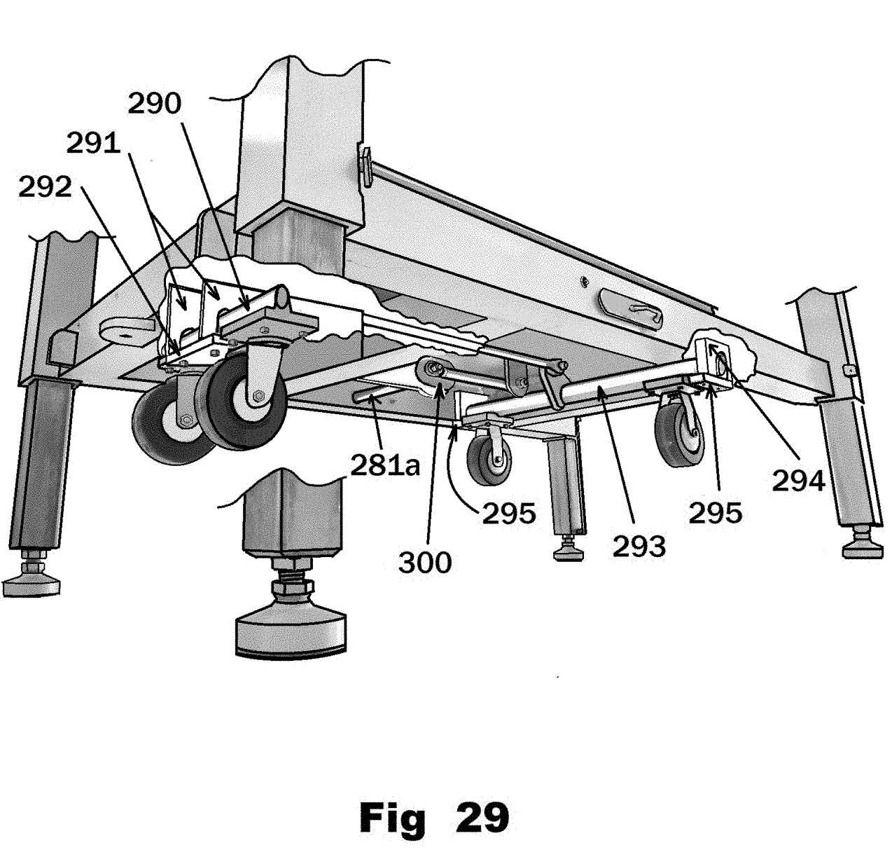

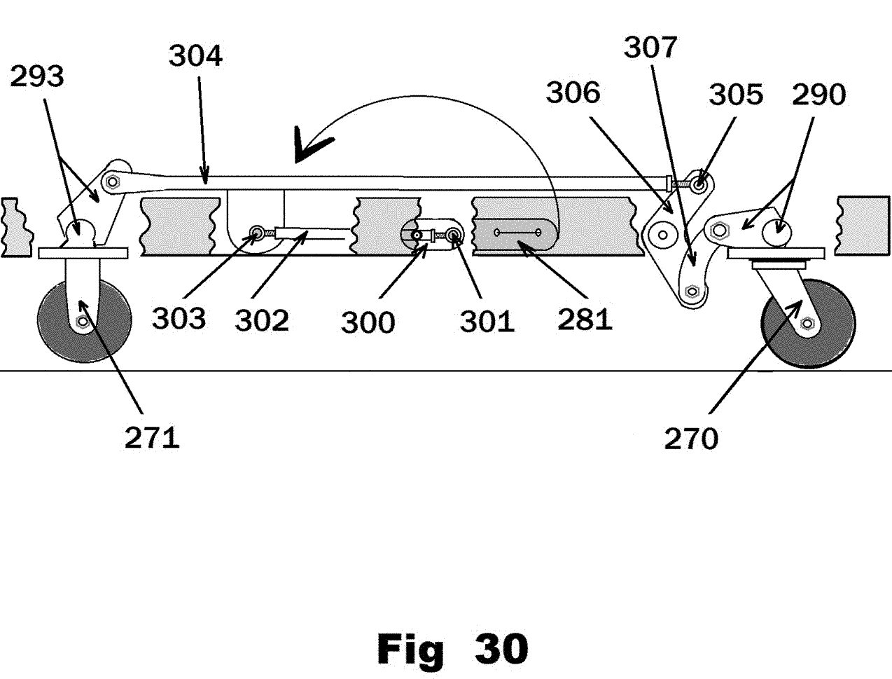

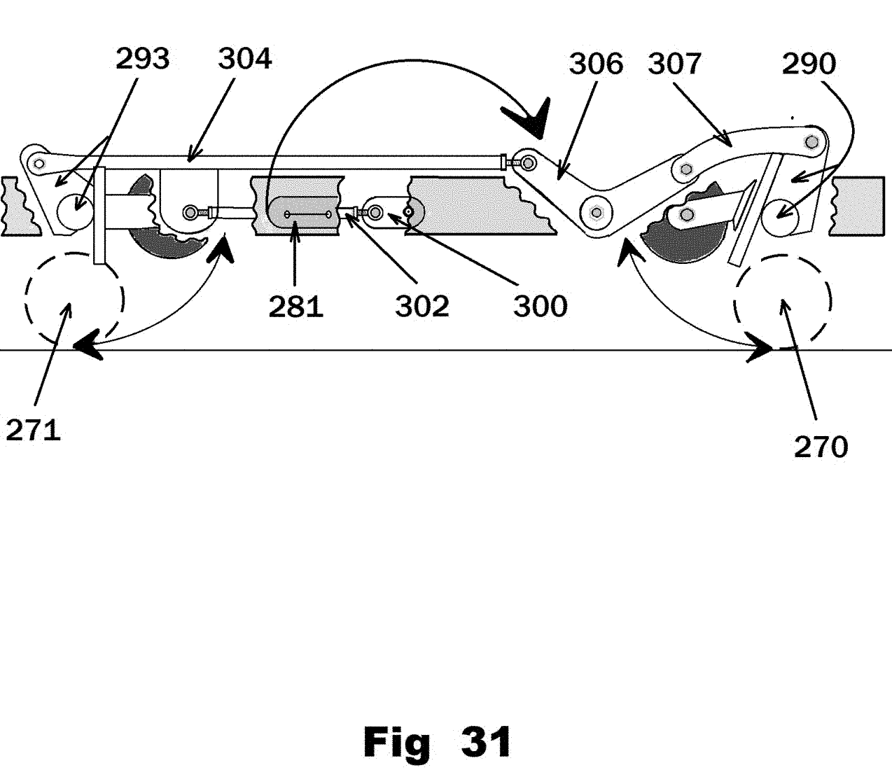

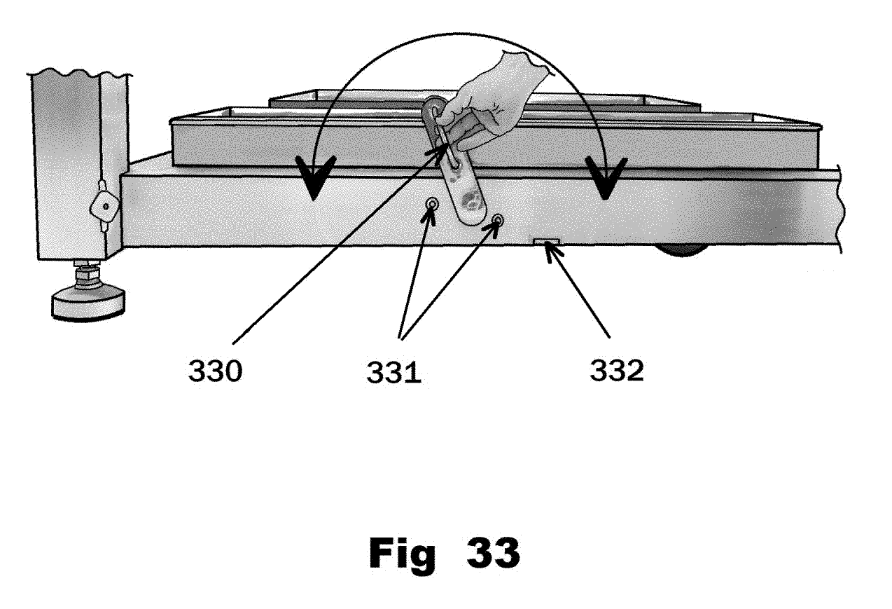

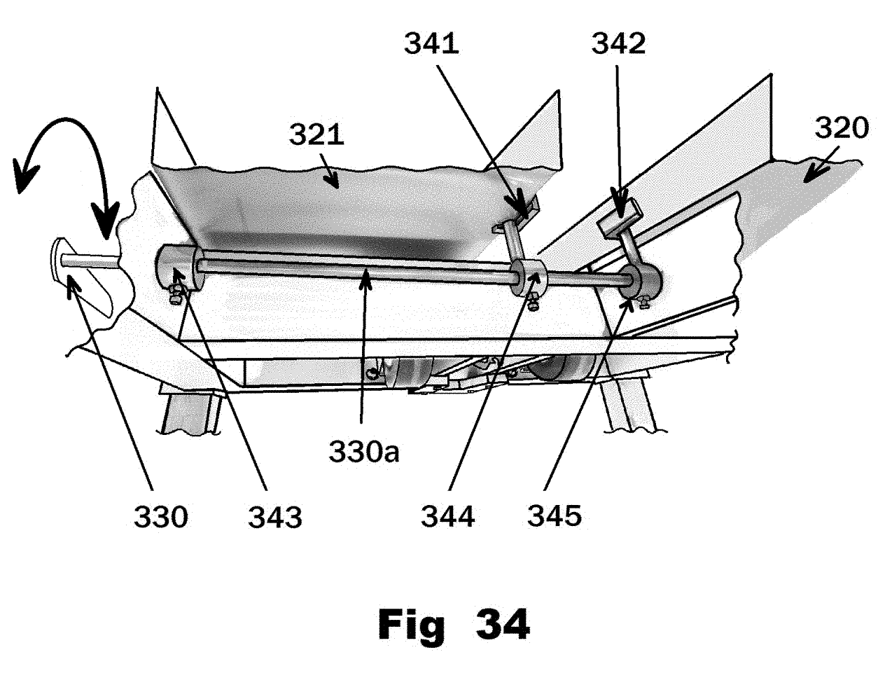

FIGS. 9-34 Feature detail . . . Part numbers/Yes

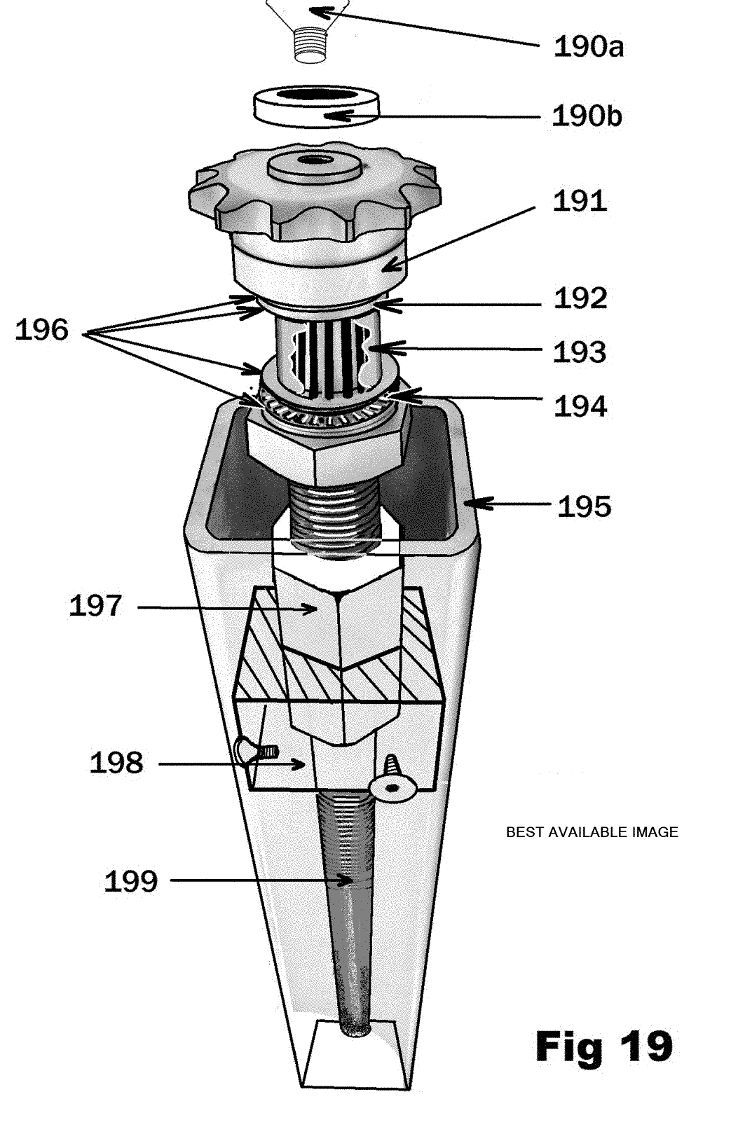

Part numbers will start with 100. The first two digits of a part number dictates the figure number it originated from, although, it may be seen in other figures. Example—part number 198 originates from FIG. 19.

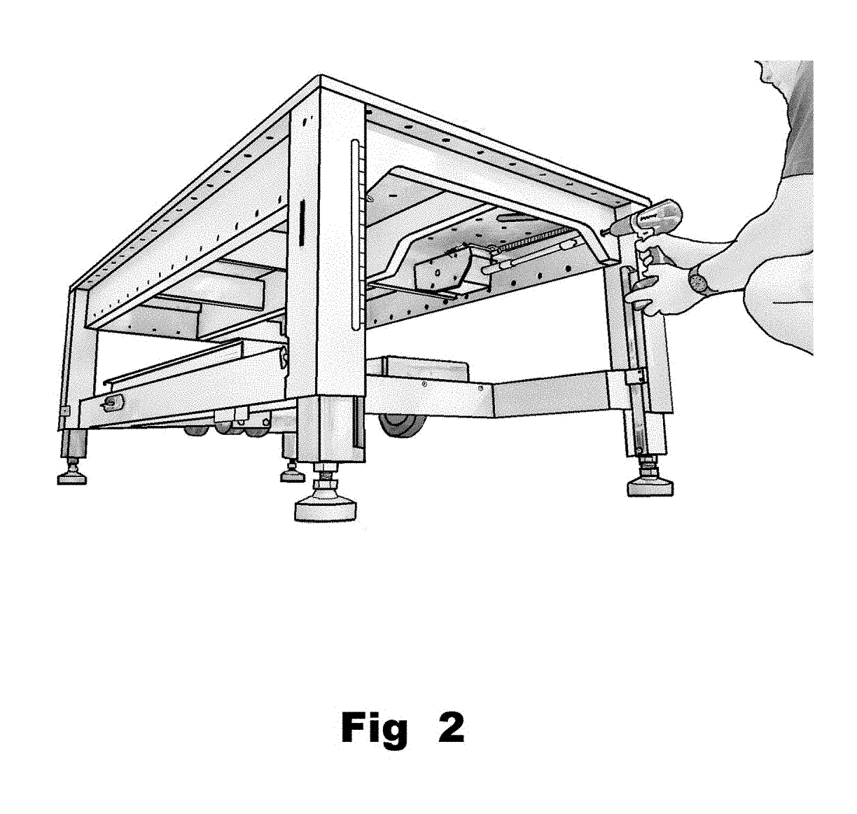

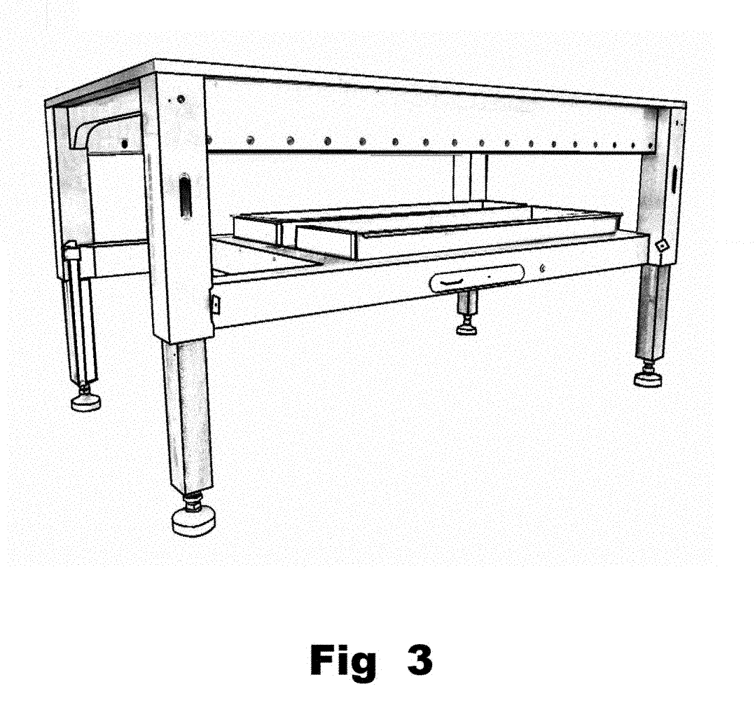

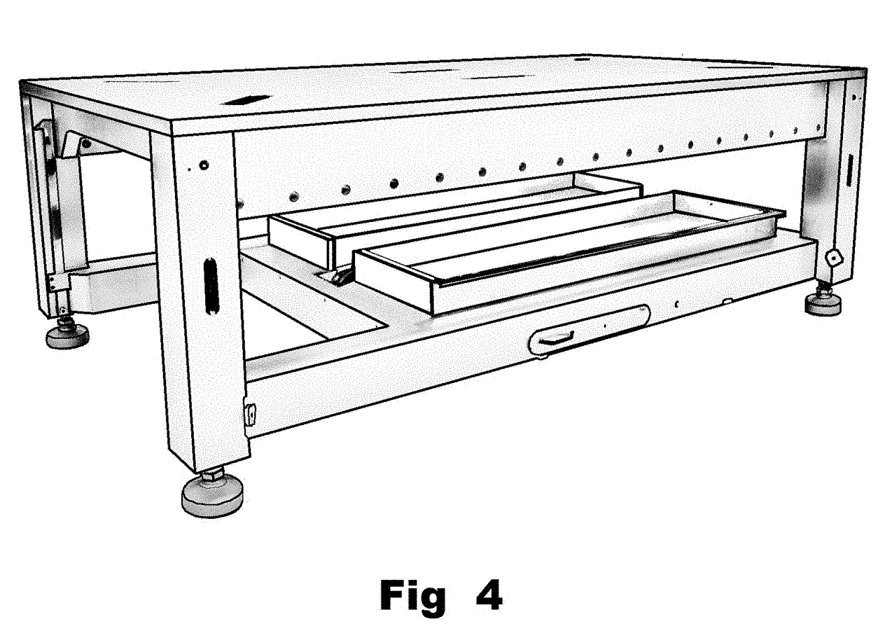

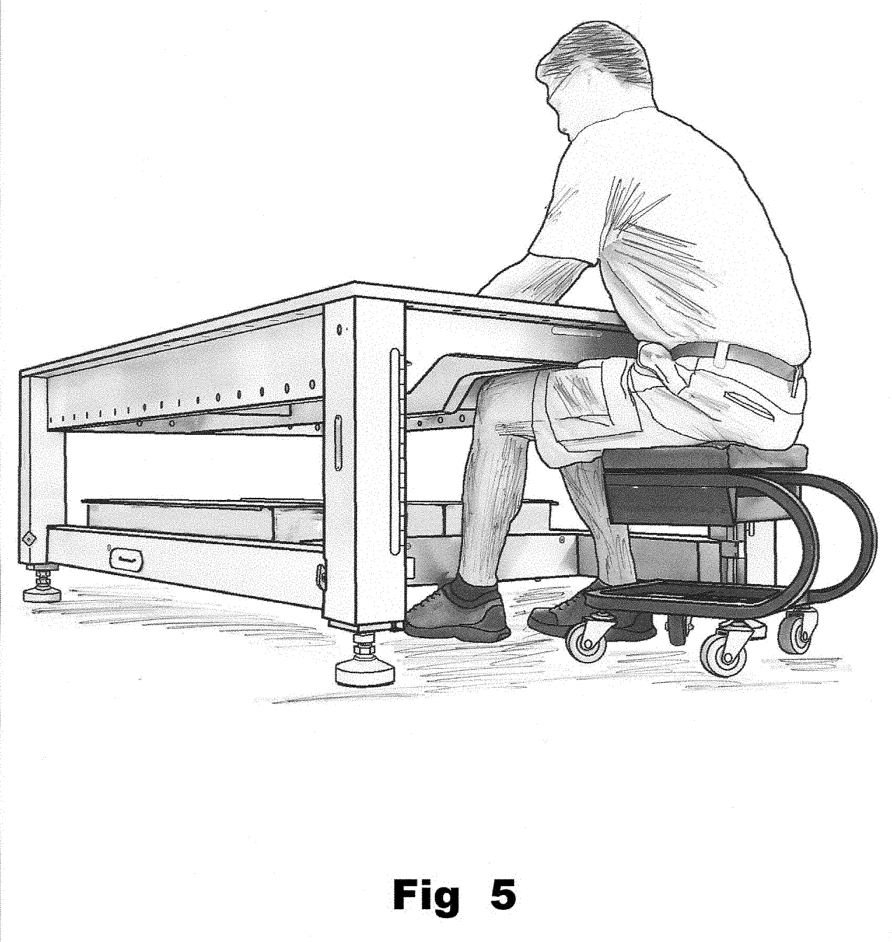

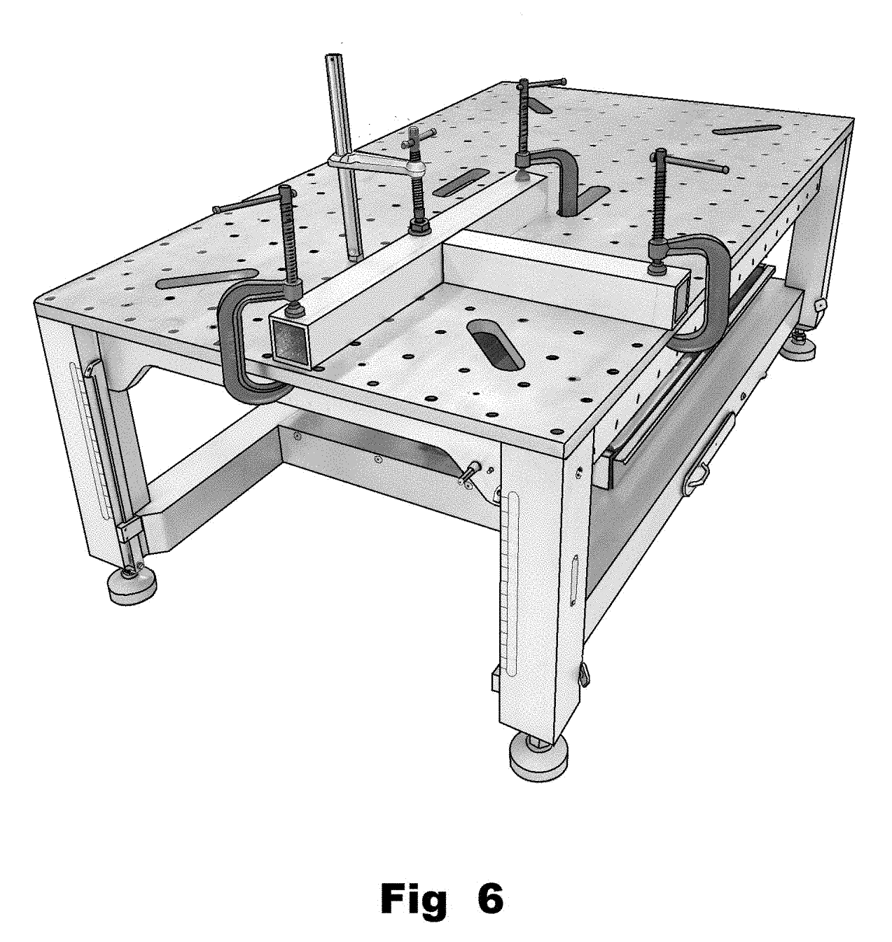

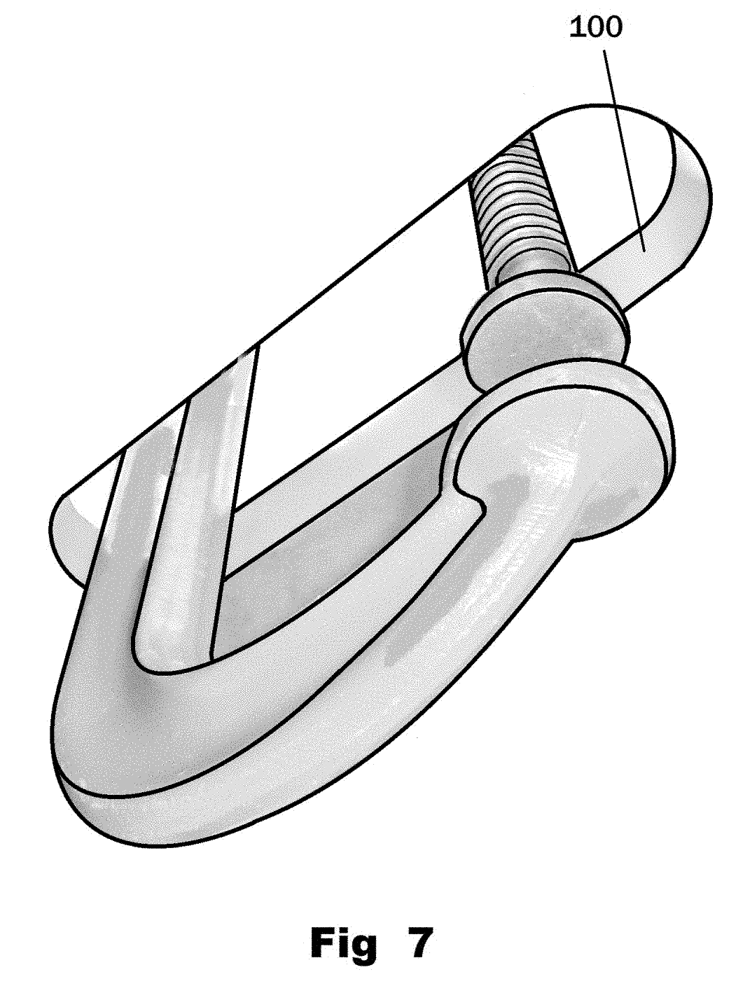

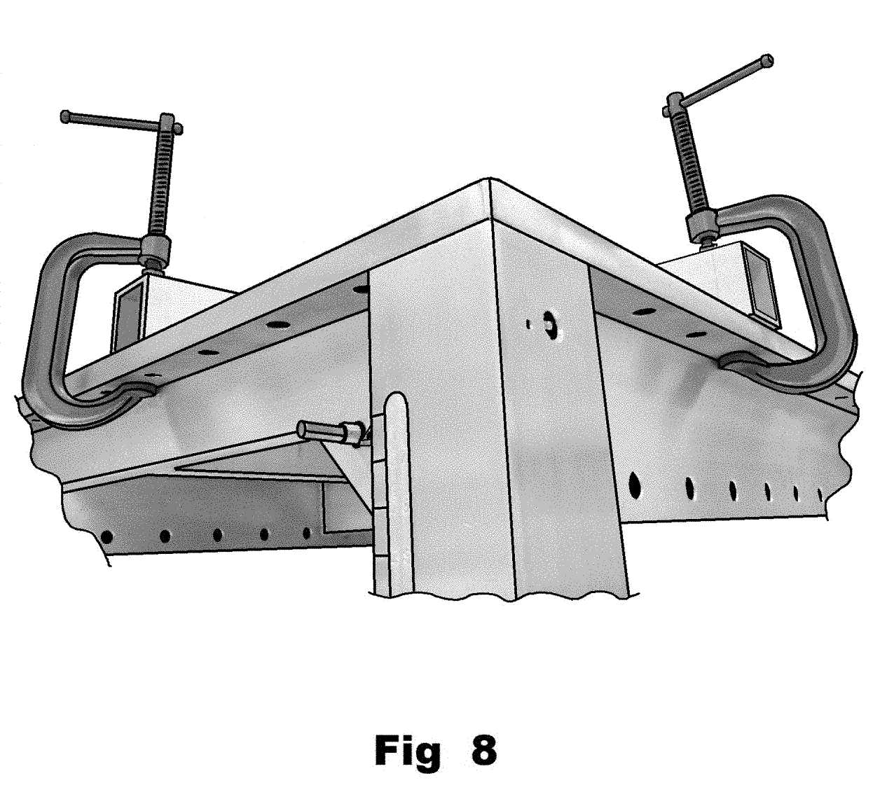

FIG. 1—Table has the ability to roll using its manually operated, independent folding wheel system. FIG. 2—Table is height adjustable using its independent elevation system, powered with a cordless drill, and works in alliance with the wheel system permitting them to be folded up. FIG. 3—The maximum elevated height of 40 inches is higher than most benches or other work surfaces, enabling precise height matching, within thousandths. FIG. 4—The lowest height of 26 inches is designed for easy loading, low profile usage and possible with the folding wheel system, which are concealed by the drawers for a clean appearance. FIG. 5—The rear end of the table is opened underneath, enabling leg and knee entrance for roll stool usage, even when table is at minimum height. FIG. 6—The one piece table top has modular hole's throughout for friction clamping, bolting, and six slotted cut outs for C-clamping, four angled and two straight. FIG. 7—Theses table top cut outs are for C-clamps, enabling them to pass through, position 360 degrees, and present clamping options uniformly in the table's center. FIG. 8—The table top design also has side over hang between the corner posts, creating more C-clamp options around the table perimeter. The overhang will also clear nuts, bolts, and the tool attached.

FIG. 9,10—The table top 100 is removable, all one piece, fastened to the frame below 101 with countersunk bolts 102. The removable top was 100 gives access to the elevating system components below while all mounting bolts thread into five solid frame beams, eliminating the need for nuts below, creating more underside usable space.

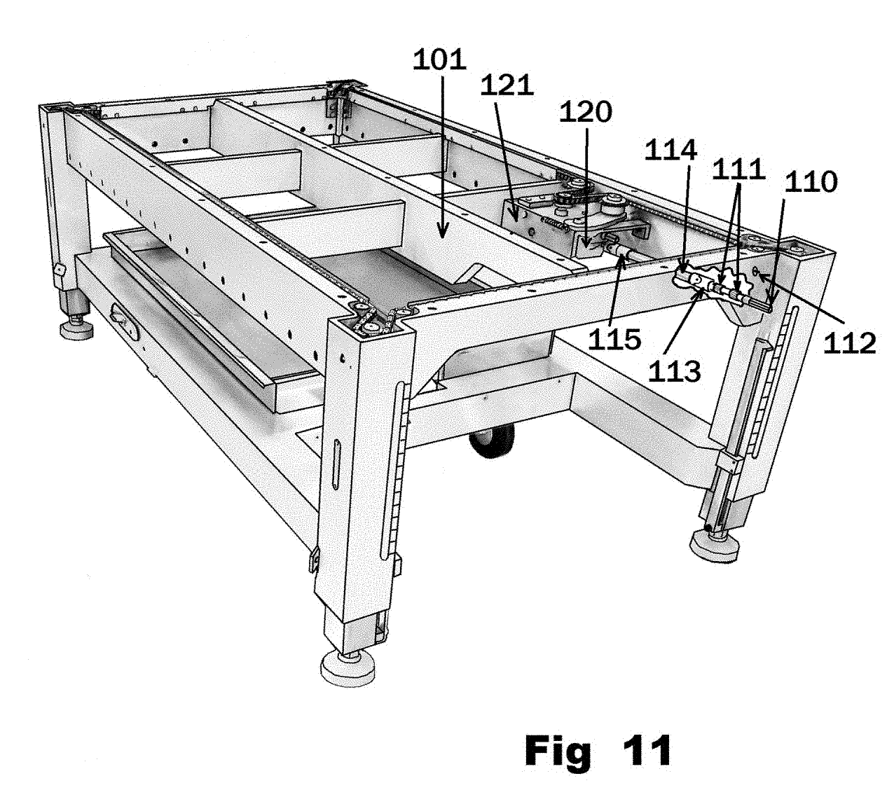

FIG. 11—Elevation System begins at the Tables right rear, in collaboration with the roll stool opening and operator knee clearance. A cordless drill is required for elevation and attaches to the input shaft 110, which is hexagon shaped preventing drill slippage. This input shaft 110 rides on two shell needle bearings 111, which are pressed into the rear arched solid frame beam, and both lubricated using one grease fitting 112. Inside the beam, the input shaft turns the first universal joint 113, which turns the driveshaft 114, and turns a second universal joint 115, then into the reduction gear 120.

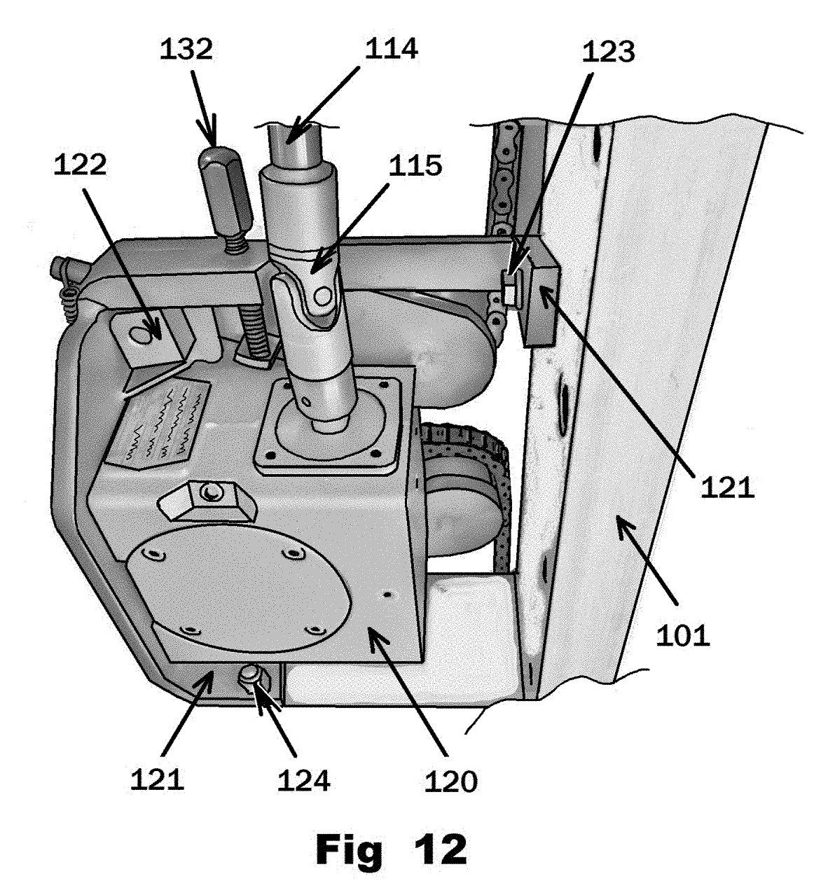

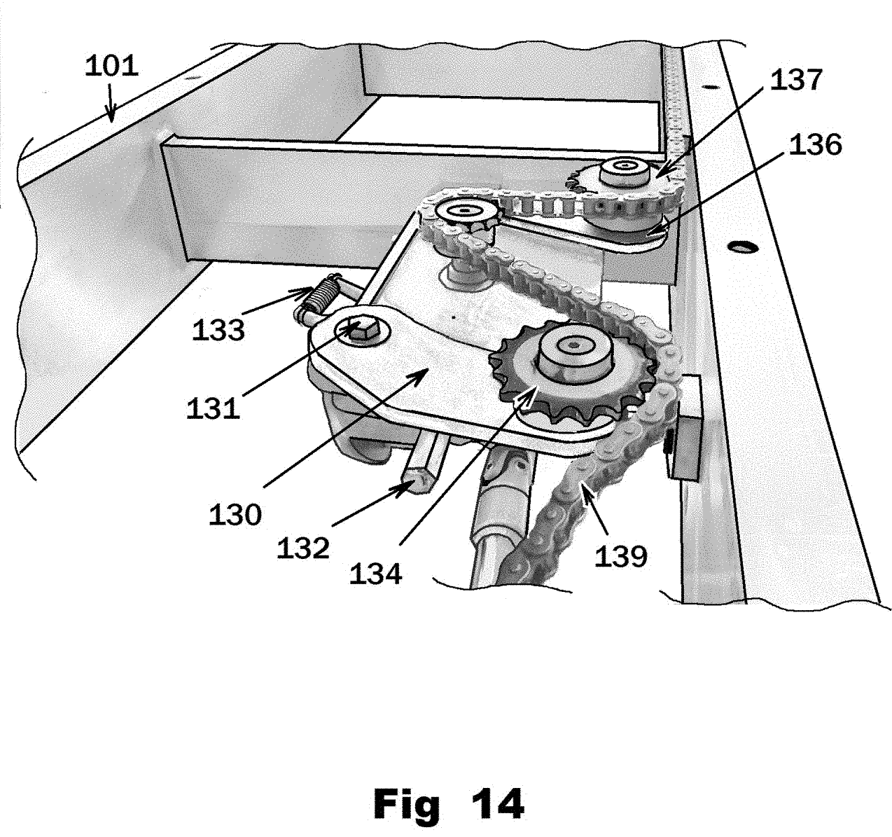

FIGS. 12-14—Elevation System reduction gear 120 is held with the gear mounting bracket 121, and it attaches to the frame 101, using bolts 123, 124. The mounting bracket 121 was designed around reduction gear 120, together they are low profile, and positioned high allowing knee entrance during roll stool usage. The rear adjustable idler arm 130, is the chain adjuster, has a sprocket at one end 134, it bolts down with a lock 135, has triple needle bearings inside, and positioned slightly under table top 100, preventing the lock bolt from backing out. The rear arm 130 is mounted with one large bolt 131, creating radius motion for chain adjustment, with a self locking square nut 122 underneath, eliminating the need for a second wrench during adjustment. The rear arm adjuster bolt 132 is very long for finger gripping and head sized matches the mounting bolt 131, allowing one wrench to turn both The rear arm 130 also has a return spring 133 maintaining a loaded, accurate feeling during adjustment with enough swing for easy chain removal, displayed in FIG. 14 only. The forward arm 136 is non adjustable, bolts directly to the reduction gear 120, and holds the second gear idler sprocket 137, and bolted down with a lock 135 and rides on triple needle bearings. When the reduction gear drive sprocket 138 turns, the chain 139 travels around the fixed idler sprocket 137, onto the chain guides.

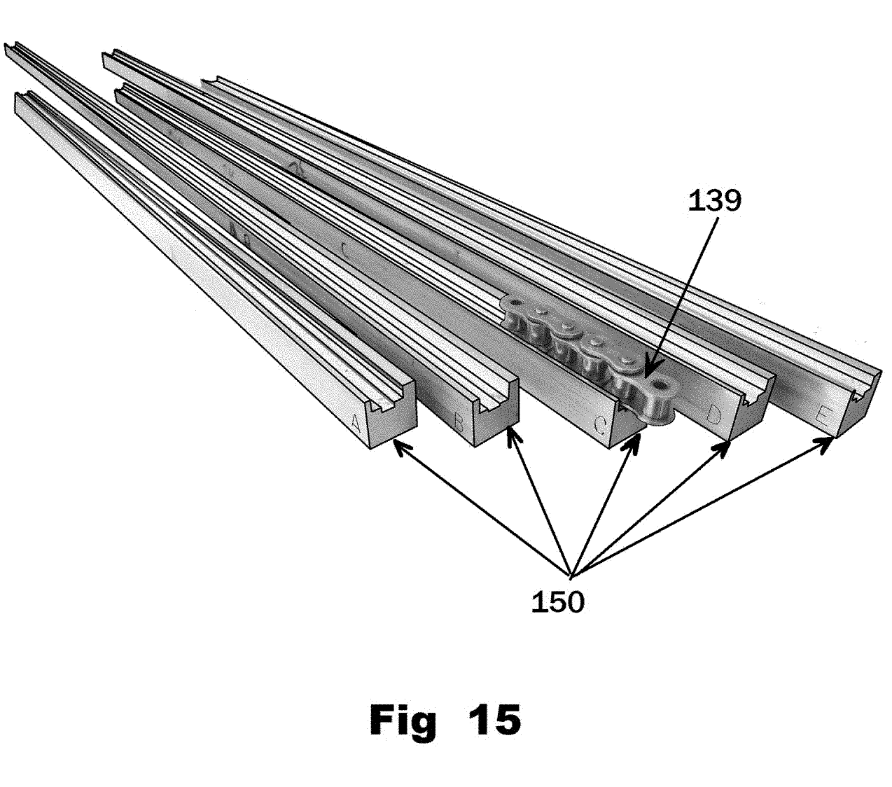

FIG. 15,16—Elevation system chain guides 150 are separate, indexed, adjustable and mounted to the frame 101 with bolts 160. The chain guides 150 are solid, have a female profile machining the chain profile 139 maintaining precise alignment. Dust shields 161 are attached using screws 162 alongside all the chain guides, also height adjustable, and can be positioned against the table top 100 underside, preventing dust, debris and the chain 139 visibility.

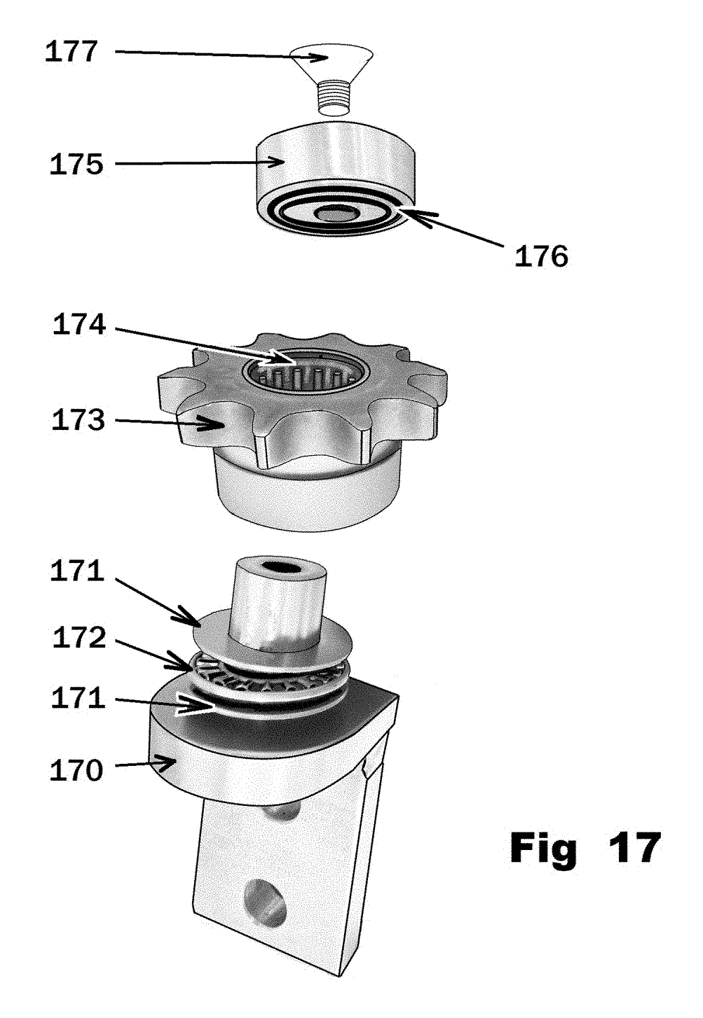

FIG. 17,18—Elevation system chains 139 next step is to make the turn into the corner posts using the post idler sprockets 173. The table has eight post idler assemblies, they are positioned in line with the chain guides 150 redirecting the chain 139 outward to the driveshaft sprockets 191, and necessary for the table top overhang. Post idler assemblies consist of an idler bracket 170, lower thrust washer 171, thrust bearing 172, upper thrust washer 171, sprocket 173, shell needle bearing 174, upper top lock bushing 175, with grease grooves 176, and held down with an allen bolt 177. Each idler assembly mounts using two bolts 180, and the rounded male bracket 170, sets into a round female pocket machined into the frame side beams 101, working in alliance with the mounting bolts 180. Idler locks 175 positions are slightly below table top preventing the lock bolt 177 from coining out. Once the chain 139 leaves the first idler sprocket 173, it then travels outward to the nearby driven sprocket 191, wrapping it halfway, exiting back inward to the next idler sprocket 173, and onto to the next chain guide 150. This process happens simultaneously with all four corners during elevation.

FIG. 19-23—Elevation system legs 195 are the same, four total, all elevate inside the frame posts 101, each has a driven sprocket 191, attaches to the driveshaft 199, held down with an upper lock 190b, with bolt 190a. Lock 190b positioned slightly under the table top preventing bolt from coming out. During elevation, driveshaft 199 rotates, it has a hex driven nut 197 which is held by the hex nut cradle 198, it's bolted inside the leg 195. The nut cradle 198 allows the driven nut 197 to rock slightly, creating self alignment throughout elevation. Two bolts 210 protrude through the legs 195, into pockets on the nuts 197, keeping the floating nuts 197 in the nut cradles 198 as load reverses while legs are in the air.—For the driveshaft 199 in relation to the frame 101, it's force is transferred to the frame 101 thrust plates through three bearings, a rotational shell needle bearing 193, a lower thrust bearing 194 for the table weight, an upper thrust bearing 192 for legs in the air, and both on hardened thrust washers 196. Each post is lubricated though one zirk fitting 200, the grease travels through thrust plate passages 201, then into all three bearings 192, 193, and 194. Each post also has a water drain hole 231 next to the grease fitting 200, preventing water pooling above the thrust plates and bearing damage. For the elevating legs below 195, all four have threaded plates in the bottom accepting a leveling mount 211, which locks in place with nut 212, and adjusted when the legs touch the floor. These four leveling mounts 211 are necessary for uneven floors, maintaining accuracy, and preventing frame 101 deflection. Leveling mounts 211 are only adjusted when table is relocated. All elevating legs 195 have a play remover 223, which are angle positioned on the frame 101 posts, in areas that won't catch clothing, and push the leg 195 corner into the inner frame post corner, using V into V force. Leg 195 play is eliminated by hand tightening the play removers 223, and this design prevents X & Y movement of the leg 195 completely, with one screw rather than two. Each frame 101 post has clear window 221 held in place with two screws 222 and covers an oval hole 220 on each frame post. These oval holes 220 are for visibility of the internal moving components, and large enough to angle a grease brush 232 allowing lubrication to the entire driveshaft 199 length.

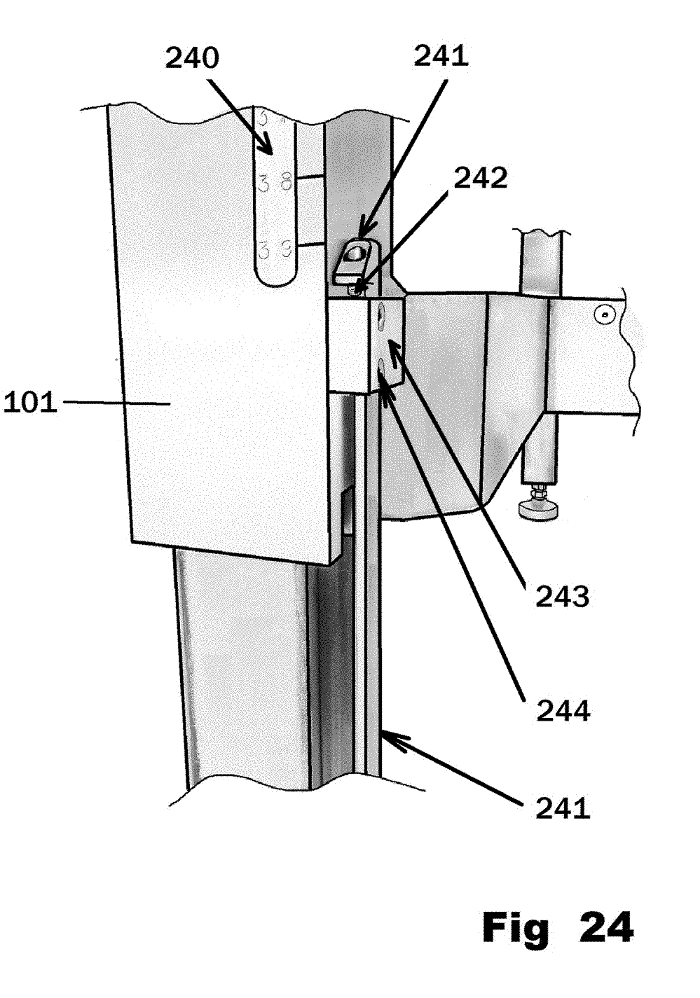

FIG. 24-26—Elevation system has lift off prevention, it maintains adequate leg length inside the frame post at maximum height. Maximum height is mechanically controlled using two leg stops 241, 251, they are bolted 261 to the leg 195 bottoms, and travel vertical almost the leg length. Each leg stop 241, 251, has an upper head, with an inner adjusting screw 242, 252 for precise stop timing adjustment, enabling both stops to touch at the same time, loading two legs 195, simultaneously The stop brackets are 243, 253, which are bolted 244, 254 to the frame 101 posts, and encapsulate the sliding leg stop 241, 251 for safety. Two height gauges 240, 250 are machined into the frame posts 101 and use the leg stops 241, 251 as indicators aligning with the current height number. This design uses the leg stops 241, 251 as a dual purpose part, a leg stop and height indicator, always in plain view, especially convenient during elevation.

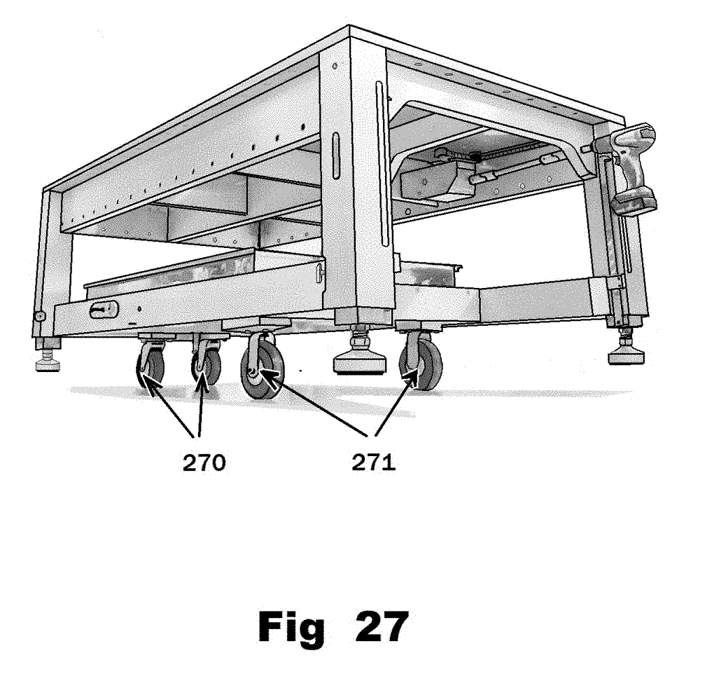

FIG. 27-31—Wheel System is independent, has four casters, two front steering 270, two rear rigid 271, and all fold up in conjunction with the elevation system, achieving the tables low height. To fold the wheels 270, 271, the table must be elevated on the legs 195, and wheels off the ground. Once up, A side control handle 281 rotates from 9 pm to 3 pm and brings the wheels 270, 271 from full up to full down, or vice versa. The control lever 281 operates on the right side lower frame 101, has two lever stops 283, 284, and position is maintained with detent balls 282 that enter provisions in the control handle 281. The lever handle 281 is designed smooth, will not catch clothing, and part of the shaft 281a which passes through two frame 101 beams used for support. Once through the rails, A keyed pitman arm 300 holds the handle assembly 281, 281a in place, and transfers the rotational leverage into the draglink 302, by use of rod ends 301, 303. Rod end 303 attaches to a ty rod 304 bracket, which is connected to the rear axle 293 and front reversing bellcrank 306. The rear axle 293 is pushed rearward creating ninety degrees of swing, and folding the rigid casters 271 forward, up into the frame. The rear axle 293 is held in position with two machined side plates 294, which are part of the frame 101, and two locking plates underneath 295 keeping the axle 293 in place when wheels lift off the ground. The front axle 290 is more complex as its movement is reversed in relation to the rear, and swing distance increased. The ty rod 304 is connected to the reversing bell crank 306 with a rod end 305, then through two connector plates 307 and finally to the front axle 290. The bell crank 306 reverses the incoming ty rod motion, enabling the front axle 290 and rear axle 293, to fold towards each other, providing the longest wheelbase possible. The bell crank 306 also increases the pivoting movement of the front axle 290 to a 110 degrees, surpassing the rear axle 293, which is 90 degrees. This was done to even out the wheels when folded up, since the front swivel casters 270 hang lower as gravity swivels them down. The front axle 290 also has suspension characteristics designed into it, as it pivots 2 degrees for uneven floors during rolling. This is done with the front frame brackets 291, creating pivot point, and allowing the front axle 290 to rock, basically acting as three wheeler on four wheels. A bottom lock plate 292 keeps the axle 290 in place when wheels are lifted. This front suspension prevents frame 101 twist load, while rolling over uneven floors, allows hard wheels for easy pushing, and eliminates the need for pneumatic tires not suited for a welding table.

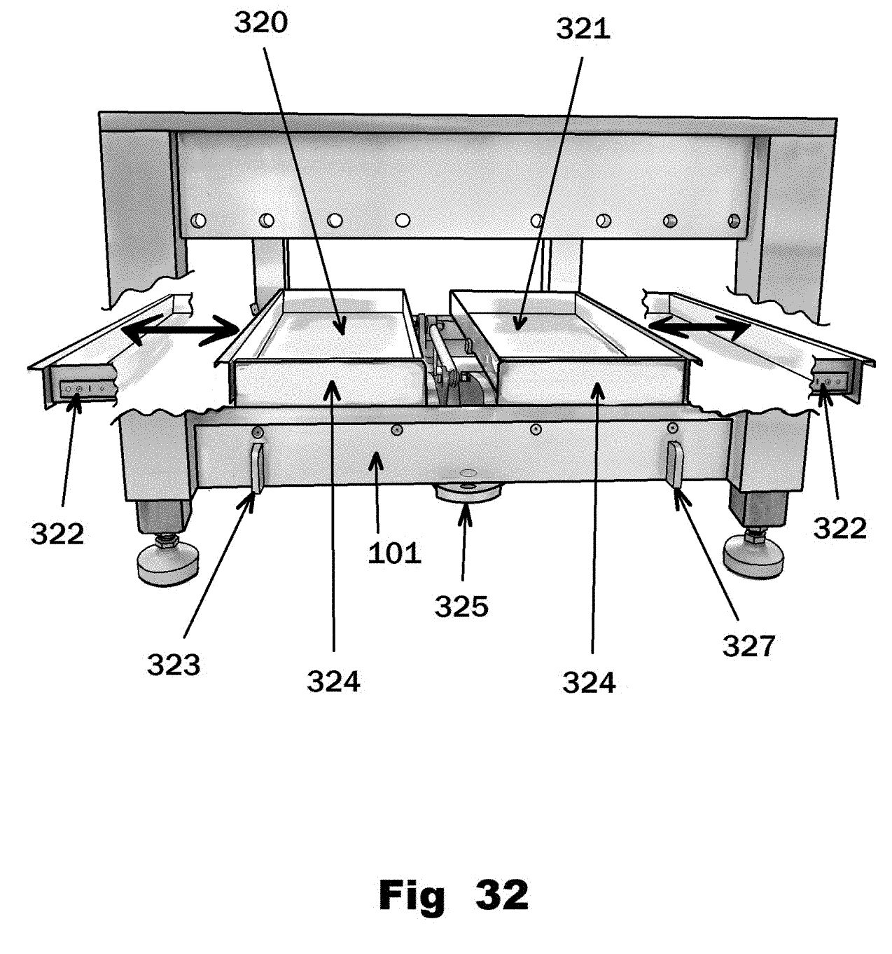

FIG. 32-34—Drawers 320, 321, are an open design, conceal the wheel system, ride on four ball bearing sliders 322, which bolt inside four recessed slider brackets 324, and they are mounted directly to the frame 101. The drawers 320, 321 can be locked for movement, and done so with a side handle 330, mounted on the left side lower frame 101, it rotates from 9 am to 3 pm, has one frame stop 332, and two detent ball assemblies 331 holding locked, or unlocked position with a provision in the handle 330. The handle 330 and shaft 330a are one piece, the shaft 330a comes through the outer frame rail, goes through the handle lock 343 through the left locking cam 344, through the right locking cam 345, and into the center frame 101 bracket for end support. The locking cams 344, 345 will swivel up into the drawer catches 341, 342 when the arm 330 is in the lock position. Final accessories on the table include two grounding brackets 323, 327 located on the lower frame beam 101 front side, with a tow plate 325 between them, designed for a shackle when towing the table, all positioned even with the table top 100, preventing leg obstructions.

1- A welding table compromising:
A frame consisting of a series of upper and lower beams intersecting into corner posts on the innermost side.
A frame opening beneath table on one end, having shortened upper beams, and lower beam set back underneath table, resembling letter “H” from above,
A frame with bolt provisions for a single piece table top,
An elevation system, independent,
A folding wheel system, independent.
A drawer system

2- The welding table of claim 1, wherein the table top has large oval holes combined with a modular hole pattern throughout.

3- The welding table of claim 1, wherein the table top positioning over hangs upper frame beams and matches outer dimension of corner posts.

4- The welding table of claim 1, wherein the elevation system, has a hexagon input shaft, connected with a driveshaft, universal joints, a low profile reducing gear, chain idlers, sprockets, screw shafts, and telescoping legs.

5- The welding table of claim 1, wherein the elevating system rear idler arm attached with single bolt to gear bracket, square locking nut underneath, adjuster screw fixed to the gear mounting bracket, with load spring attached twin posts.

6- The welding table of claim 1, wherein the elevating system chain guides are a negative chain profile into solid material aligning side shoulders.

7- The welding table of claim 1, wherein the elevating system chain guide dust shields are side mounted attached with screws.

8- The welding table of claim 1, wherein the elevating system post idler assemblies are angled material with sprocket stub shafts, bolted with the vertical portion, and horizontal portion has round nose engaging into rounded frame beam provisions.

9- The welding table of claim 1, wherein the elevating system has upper thrust in each frame post, a main thrust bearing, a centralizing shell bearing, and an upper thrust bearing, grease tunneling, one grease fitting.

10- The welding table of claim 1, wherein the elevating system driven nuts are floating, lower nut rests in side hexagon cradles bolted within legs, and upper nut has two provisions 180 degrees apart.

11- The welding table of claim 1, wherein the elevating system sight holes on each, post are vertical, oval shaped, centrally positioned to the internal driveshaft, and covered with clear removable material.

12- The welding table of claim 1, wherein the elevating system leg play removers screw into each lower frame post corner at 45 degrees.

13- The welding table of claim 1, wherein the elevating system leg stops for down, are the internal post thrust plates contacting leg top.

14- The welding table of claim 1, wherein the elevating system leg stops for up, have top heads with internal adjusting screws, contacting the guiding stop brackets, bolted to the posts.

15- The welding table of claim 1, wherein the elevating system has post mounted height charts, indicated with the leg stop heads.

16- The welding table of claim 1, wherein the wheel system is folding with an outer mounted lever connected to a shaft, a pitman arm, a draglink, then ty rod.

17- The welding table of claim 1, wherein the wheel system reversing bell crank has two levers attached to a center hub, attached between front axle frame connectors.

18- The welding table of claim 1, wherein the wheel system front axle is held with twin slotted areas in frame connectors.

19- The welding table of claim 1, wherein the drawers positioning conceals the folding wheel system.

20- The welding table of claim 1, wherein the drawers are locking using a side lever, attached to a shaft with sliding lock cams.
